(19) United States
(12) Patent Application Publication
(10) Pub. No.: US 2018/0282970 A1
(43) Pub. Date: Oct. 4, 2018

(54) SHOVEL COMMUNICATIONS SYSTEM, MULTICOPTER, AND SHOVEL

(71) Applicant: SUMITOMO HEAVY INDUSTRIES, LTD., Tokyo (JP)

(72) Inventors: Masato KOGA, Kanagawa (JP); Masahito INDOH, Kanagawa (JP)

(21) Appl. No.: 16/001,277

(22) Filed: Jun. 6, 2018

Related U.S. Application Data
(63) Continuation of application No. PCT/JP2016/086214, filed on Dec. 6, 2016.

(30) Foreign Application Priority Data
Dec. 8, 2015 (JP) 2015-239012
Dec. 14, 2015 (JP) 2015-242802

(51) Int. Cl. E02F 9/20; B64C 27/08; B64C 39/02; B64D 47/08; E02F 9/26; H04N 7/18

(52) U.S. Cl. CPC E02F 9/20; B64C 27/08; B64C 39/024; B64C 2201/123; E02F 9/26; H04N 7/18; B64D 47/08

(57) ABSTRACT

A shovel communications system includes a multicopter, an operation apparatus, and a shovel. The multicopter is configured to fly in response to an operation command. The operation apparatus is configured to transmit a radio signal corresponding to the operation command when the operation command is input to the multicopter, and to output information when receiving the information from the multicopter. The shovel includes a relay configured to relay a radio signal communicated between the operation apparatus and the multicopter.

### CROSS-REFERENCE TO RELATED APPLICATIONS

This application is a continuation application filed under 35 U.S.C. 111(a) claiming benefit under 35 U.S.C. 120 and 365(c) of PCT International Application No. PCT/JP2016/086214, filed on Dec. 6, 2016 and designating the U.S., which claims priority to Japanese Patent Application No. 2015-239012, filed on Dec. 8, 2015, and Japanese Patent Application No. 2015-242802, filed on Dec. 14, 2015. The entire contents of the foregoing applications are hereby incorporated herein by reference.

### BACKGROUND

### Technical Field

The present invention relates to shovel communications systems, multicopters, and shovels.

### Description of Related Art

A technique that uses a camera to enhance visibility around a construction machine such as a shovel to ensure security is known. For example, a rear view camera and a side view camera are installed in a shovel, and images captured by these cameras are displayed on a display screen. A guideline serving as a measure of distance from the shovel is displayed over an image of surroundings.

### SUMMARY

According to an aspect of the present invention, a shovel communications system includes a multicopter, an operation apparatus, and a shovel. The multicopter is configured to fly in response to an operation command. The operation apparatus is configured to transmit a radio signal corresponding to the operation command when the operation command is input to the multicopter, and to output information when receiving the infatuation from the multicopter. The shovel includes a relay configured to relay a radio signal communicated between the operation apparatus and the multicopter.

### BRIEF DESCRIPTION OF THE DRAWINGS

FIG. 1 is a schematic diagram of a shovel communications system according to an embodiment;

FIG. 2A is a schematic diagram of a work site of a shovel;

FIG. 2B is a schematic diagram of a multicopter;

FIG. 2C is a diagram illustrating an image displayed on a display screen of an operation apparatus;

FIG. 2D is a block diagram of the shovel according to the embodiment;

FIG. 3 is a schematic side view of another work site of the shovel;

FIG. 4 is a diagram illustrating an arrangement of shovels, a multicopter, and an operation apparatus included in a shovel communications system in a vertical plane;

FIG. 5 is a diagram illustrating the arrangement of shovels, a multicopter, and an operation apparatus constituting the shovel communications system in a horizontal plane;

FIG. 6 is a diagram illustrating an arrangement of shovels and a multicopter included in a shovel communications system according to another embodiment in a horizontal plane;

FIG. 7 is a diagram illustrating another arrangement of shovels and a multicopter included in a shovel communications system according to the other embodiment in a horizontal plane;

FIG. 8 is a diagram illustrating an arrangement of shovels and multicopters included in a shovel communications system according to yet another embodiment in a horizontal plane;

FIG. 9 is a diagram illustrating an arrangement of a shovel and multicopters included in a shovel communications system according to yet another embodiment in a horizontal plane;

FIG. 10A is a diagram illustrating an arrangement of shovels and a multicopter included in a shovel communications system according to still another embodiment in a vertical plane;

FIG. 10B is a schematic diagram of the multicopter;

FIG. 10C is a perspective view of the operation apparatus;

FIG. 11 is a schematic diagram of a shovel communications system according to an embodiment;

FIG. 12 is a side view of a shovel included in the shovel communications system according to the embodiment;

FIG. 13 is a side view of an upper rotating structure and a cabin of the shovel;

FIG. 14 is a plan view of the upper rotating structure and the cabin of the shovel;

FIG. 15 is a perspective view of a multicopter port and a multicopter landing on the multicopter port;

FIG. 16 is a plan view of a recess of the multicopter port;

FIG. 17 is a block diagram of the shovel according to the embodiment;

FIG. 18A is a diagram illustrating an image displayed on a display device of the shovel;

FIG. 18B is a diagram illustrating another image displayed on the display device of the shovel;

FIG. 19 is a diagram illustrating a sequence of signals communicated between the shovel and the multicopter and an operation flow; and

FIG. 20 is a schematic diagram of the shovel and the multicopter included in a shovel communications system according to another embodiment.

### DETAILED DESCRIPTION

According to conventional shovels on which cameras are mounted, only a side view and a rear view from the rotating structure of a shovel can be imaged. In shovel work, however, an area that is difficult to directly see in the line of sight from the shovel may become a target of work. If it is possible to operate a shovel while checking an image of an area that is a target of work, the efficiency of work improves.

Furthermore, in some cases, a number of shovels work in a work site where a large area is a target of work. In this case, it is convenient for a work site supervisor if the progress of the respective works of the shovels in the large work site can be checked with an image. Furthermore, it is convenient if it is possible to obtain or send not only image information but also various kinds of information in a large work site.

According to an aspect of the present invention, a shovel communications system capable of obtaining and/or sending information in a work site of a shovel is provided.

According to an aspect of the present invention, a shovel applicable to this shovel communications system is provided.

According to an aspect of the present invention, a multicopter applicable to this shovel communications system is provided.

According to an aspect of the present invention, because radio signals communicated between an operation apparatus and a multicopter are relayed by a relay of a shovel, it is possible to extend the distance over which the operation apparatus and the multicopter can communicate with each other. As a result, even when the distance from the operation apparatus to the multicopter increases, it is possible to obtain and send various kinds of information, using the multicopter flying in a work site.

Furthermore, according to an aspect of the present invention, the multicopter flying in the work site and the operation apparatus communicate with each other, so that it is possible to obtain and send information in the work site through the multicopter. The multicopter flying in a large work site can be supplied with charging electric power from a multicopter port of a shovel working nearby.

Embodiments of the present invention are described below with reference to the accompanying drawings.

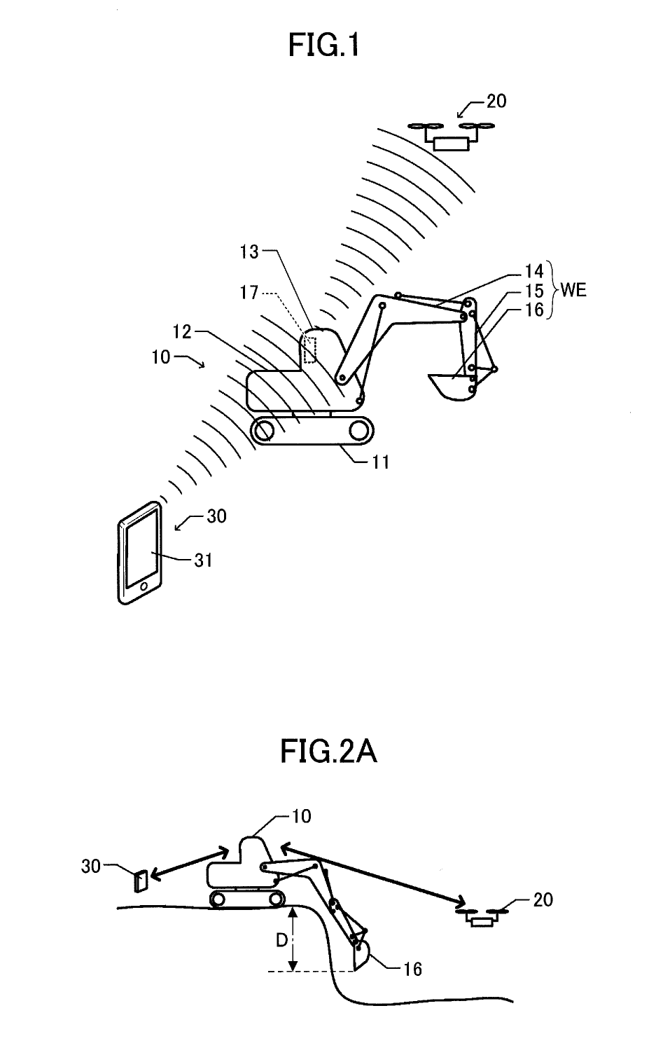

FIG. 1 illustrates a schematic diagram of a communications system for a shovel (shovel communications system) according to an embodiment. The shovel communications system according to the embodiment includes a shovel 10, a multicopter 20, and an operation apparatus 30.

The shovel 10 includes a traveling undercarriage 11, an upper rotating structure 12, and a working element WE. The upper rotating structure 12 is rotatable relative to the traveling undercarriage 11. The working element WE includes a boom 14, an arm 15, and a bucket 16. A breaker, crusher, cutter, lifting magnet or the like may be attached in place of the bucket 16.

A relay 17 is mounted on the upper rotating structure 12. The relay 17 relays radio signals communicated (transmitted and received) between the operation apparatus 30 and the multicopter 20. That is, the shovel 10 serves as a relay node of a radio communications network.

The operation apparatus 30 includes an input device and a display screen. For example, a touchscreen 31 serves as both an input device and a display screen. An operation command to the multicopter 20 is input through an operation on the touchscreen 31. The operation apparatus 30 transmits a radio signal corresponding to the input operation command. Examples of operation commands include instructions on a flight route and flight altitude, instructions for image acquisition, and instructions for audio output. Furthermore, in response to receiving information from the multicopter 20, the operation apparatus 30 outputs the received information to the touchscreen 31.

The multicopter 20 is an aircraft that receives an operation command from the operation apparatus 30 to perform a predetermined operation according to the contents of the operation command. The aircraft may be an airship or the like. The multicopter 20 is also referred to as drone. When the operation command indicates a flight route and flight altitude, the multicopter 20 flies in accordance with the contents of the operation command. When the operation command indicates acquisition of image data, the multicopter 20 acquires image data and transmits the acquired image data to the operation apparatus 30. For example, the multicopter 20 acquires image data to generate topographical data as construction data.

The operation apparatus 30 may be implemented by, for example, a portable information communication terminal such as a tablet terminal (tablet PC), a smartphone, or a notebook PC. The operation apparatus 30 is operated by, for example, a work site supervisor, an operator of the shovel 10, or the like. When a work site supervisor carries the operation apparatus 30, the operation apparatus 30 is placed outside the shovel 10. When an operator of the shovel 10 operates the operation apparatus 30, the operation apparatus 30 is mounted on the shovel 10.

Because the shovel 10 serves as a relay node, it is possible to increase a distance from the operation apparatus 30 to the multicopter 20 over which radio communications are performable. As a result, an operator of the operation apparatus 30 can collect various kinds of information via the multicopter 20 positioned in a range where radio waves radiated from the shovel 10 are receivable.

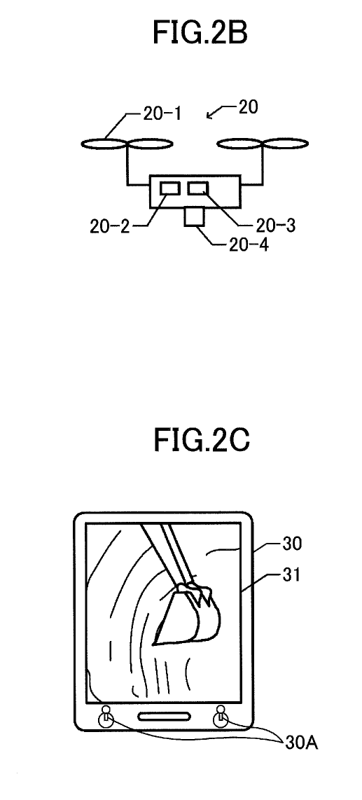

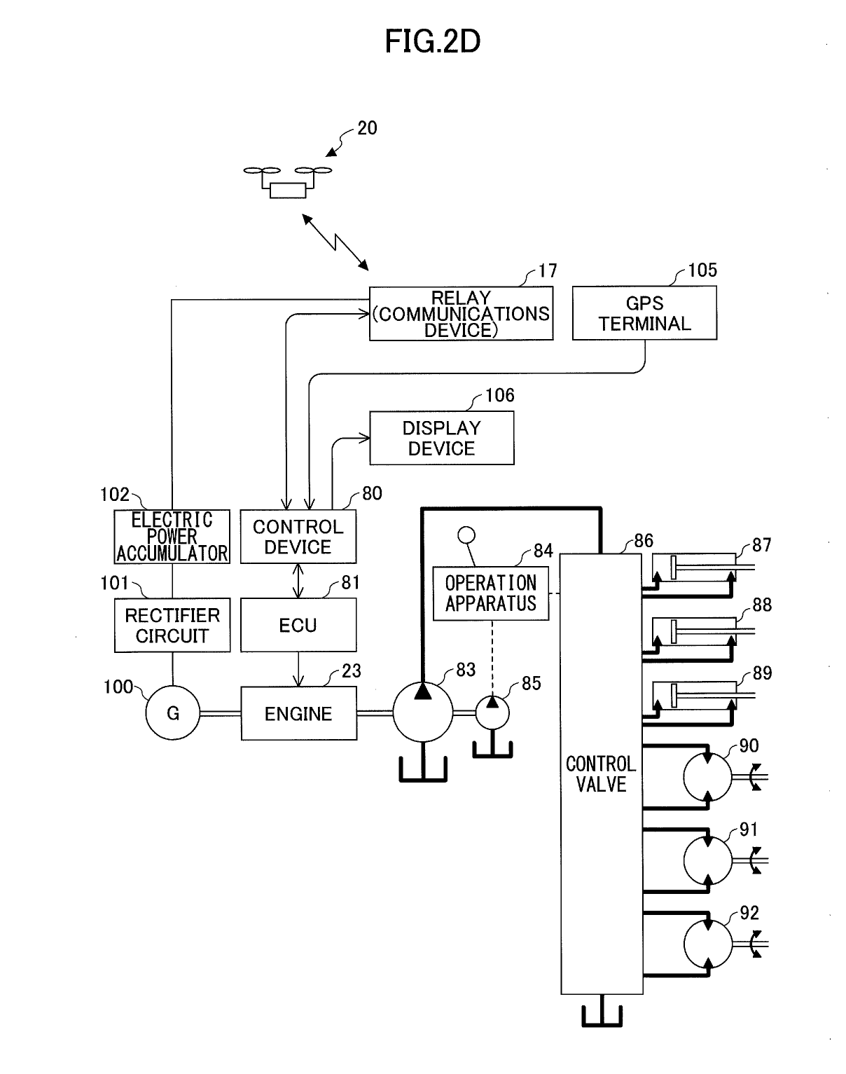

Information collected through the multicopter 20 is described with reference to FIGS. 2A through 2D.

FIG. 2A is a schematic diagram of a work site of the shovel 10 performing deep excavation work. FIG. 2A illustrates a state where the bucket 16 is lowered to a depth D. An operator of the operation apparatus 30 operates the operation apparatus 30 to cause the multicopter 20 to move to the vicinity of the work area of the bucket 16 and thereafter hover. At this point, radio signals communicated between the operation apparatus 30 and the multicopter 20 are relayed by the shovel 10. In FIG. 2A, communication channels of radio signals are indicated by the double-headed arrows.

FIG. 2B illustrates a schematic diagram of the multicopter 20. The multicopter 20 includes multiple rotor blades 20-1, a communications device 20-2, and a control device 20-3. An imaging device 20-4 is mounted on the multicopter 20. The communications device 20-2 performs radio communications with the operation apparatus 30 or the shovel 10. The control device 20-3 moves and controls the posture of the multicopter 20 and controls the imaging device 20-4 in accordance with an operation command received from the operation apparatus 30.

The control device 20-3 can hover the multicopter 20 and change the orientation of the optical axis of the imaging device 20-4 in response to a command from the operation apparatus 30. When the imaging device 20-4 has a lens having a variable angle of view, it is possible to change the angle of view in response to a command from the operation apparatus 30.

When an operation command to acquire image data is transmitted from the operation apparatus 30 to the multicopter 20, the multicopter 20 transmits image data captured by the imaging device 20-4. The transmitted image data are relayed by the shovel 10 to be received by the operation apparatus 30.

The operation apparatus 30 displays an image on a display screen based on the image data received from the multicopter 20.

FIG. 2C illustrates an image displayed on the touchscreen 31 of the operation apparatus 30. An image of the bucket 16 (FIG. 2A) and its neighborhood is displayed. When a site supervisor carries the operation apparatus 30, the supervisor can understand the progress of work from the acquired image. When the operation apparatus 30 is placed at such a position as to be viewable from an operator of the shovel 10, the operator can perform work while checking, in the image, a work area difficult to directly see. In the illustration of FIG. 2C, the operation apparatus 30 includes control sticks 30A for flying the multicopter 20. The control sticks 30A, however, may alternatively be another hardware configuration such as an arrow pad, operation levers, or a joystick, or software buttons on the touchscreen 31.

FIG. 2D illustrates a block diagram of the shovel 10 according to the embodiment. In FIG. 2D, a mechanical power system is indicated by a double line, a high-pressure hydraulic line is indicated by a thick solid line, a pilot line is indicated by a dashed line, and an electrical control system and an electric power system are indicated by a thin solid line.

An engine control unit (ECU) 81 controls an engine 23 based on a command from a control device 80. Power generated in the engine 23 is transmitted to a main pump 83, a pilot pump 85, and an alternator 100. The main pump 83 supplies hydraulic oil to a control valve 86 through a high-pressure hydraulic line.

The pilot pump 85 supplies a primary pilot pressure to an operation apparatus 84 through a pilot line. The operation apparatus 84 converts the primary pilot pressure into a second pilot pressure and supplies the secondary pilot pressure to a corresponding pilot port of the control valve 86, in accordance with an operator's operation.

The control valve 86 selectively supplies hydraulic oil to multiple hydraulic actuators in accordance with the secondary pilot pressures supplied to pilot ports. The hydraulic actuators include a boom cylinder 87 that drives the boom 14 (FIG. 1), an arm cylinder 88 that drives the arm 15 (FIG. 1), a bucket cylinder 89 that drives the bucket 16 (FIG. 1), traveling hydraulic motors 90 and 91, and a rotation hydraulic motor 92.

The alternator 100 is driven by the engine 23 to generate electric power. Alternating electric power generated by the alternator 100 is rectified by a rectifier circuit 101 to be supplied to an electric power accumulator 102. The electric power accumulator 102 is charged with the output electric power of the alternator 100.

A display device 106 is placed in a cabin 13 (FIG. 1). A variety of information on operations of the shovel 10 is displayed on the display device 106 under the control of the control device 80.

The relay 17, which is a device that relays radio signals communicated between the operation apparatus 30 and the multicopter 20, receives a supply of electric power from the electric power accumulator 102. The relay 17, for example, amplifies a signal wirelessly received from the operation apparatus 30 and wirelessly transmits the amplified signal again to the outside. According to this embodiment, the relay 17 also operates as a communications device, and performs communications with the outside under the control of the control device 80. For example, the relay 17 performs communications with the multicopter 20, the operation apparatus 30, etc. Specifically, the relay 17 transmits information on the current position of the shovel 10 detected by a GPS terminal 105 to the multicopter 20, the operation apparatus 30, etc.

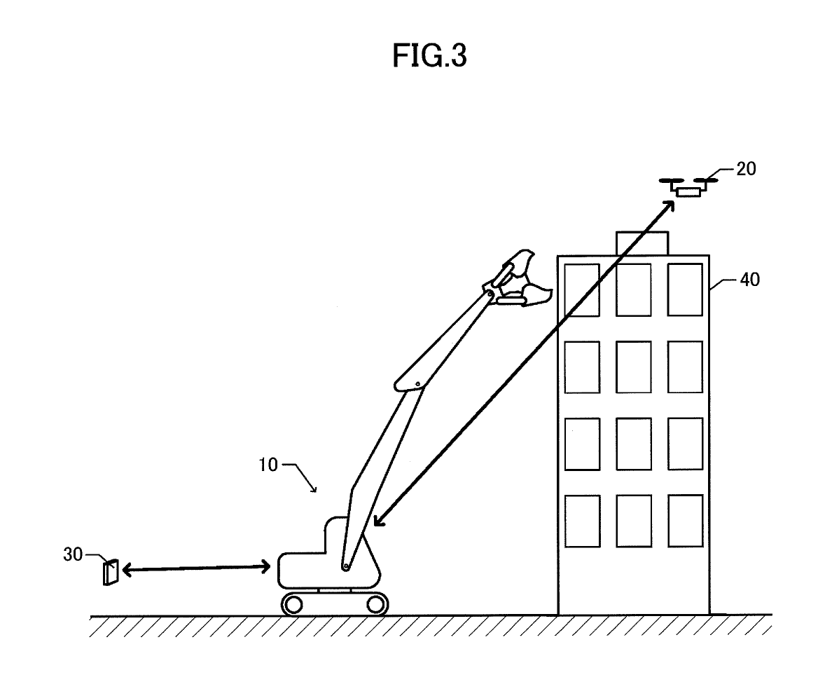

Next, another example of information collected through the multicopter 20 is described with reference to FIG. 3.

FIG. 3 illustrates a schematic side view of a work site of the shovel 10. The shovel 10 is demolishing a building 40. In FIG. 3, communication channels of radio signals are indicated by the double-headed arrows. An operator of the shovel 10 cannot visually check the condition of the rooftop of the building 40 directly. A work supervisor or the operator can acquire the image data of the rooftop of the building 40 by operating the operation apparatus 30 to hover the multicopter 20 above the rooftop. By checking the condition of the rooftop of the building 40 before demolition with an image, it is possible to perform demolition work more safely.

Even when the distance from the operation apparatus 30 to the multicopter 20 is more than the upper limit of the distance over which radio communications are performable, it is possible to ensure communications between the operation apparatus 30 and the multicopter 20, using the shovel 10 as a relay node.

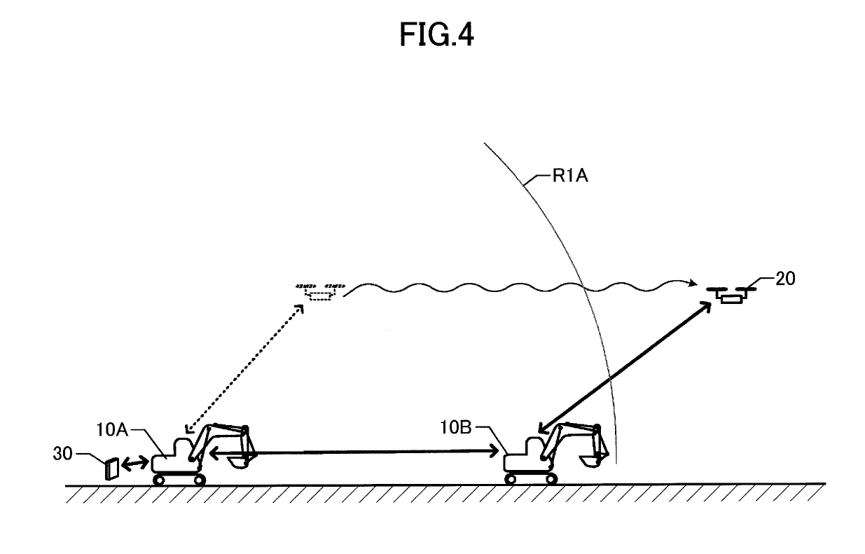

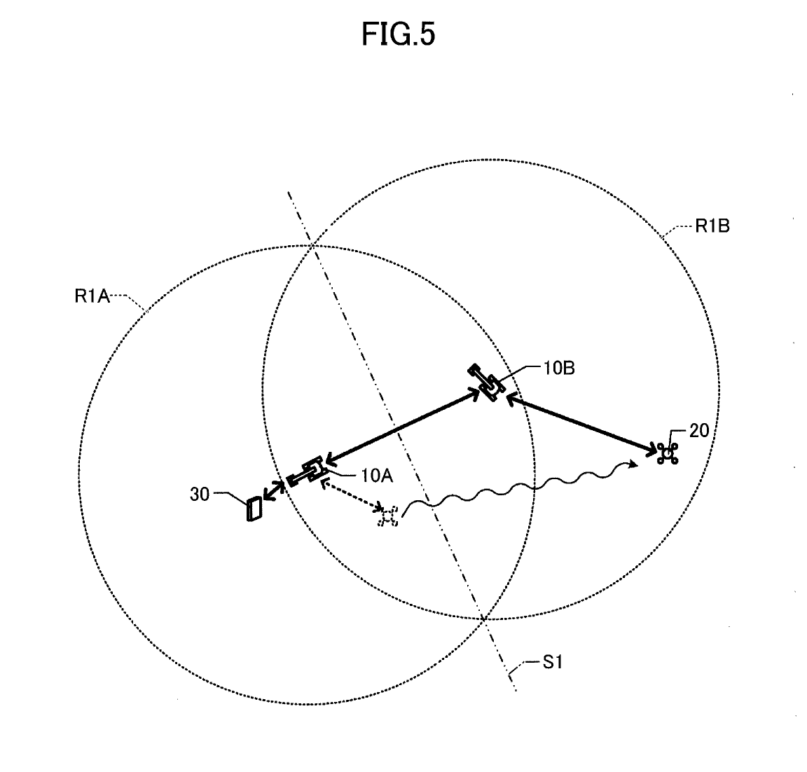

Next, a shovel communications system according to another embodiment is described with reference to FIGS. 4 and 5. In the following, differences from the embodiment illustrated in FIGS. 1 through 3 are described, and a description of a common configuration is omitted. According to this embodiment, multiple shovels work in a work site where a large area is a target of work.

FIG. 4 illustrates an arrangement of shovels, a multicopter, and an operation apparatus included in the shovel communications system in a vertical plane. FIG. 5 illustrates the arrangement of shovels, a multicopter, and an operation apparatus constituting the shovel communications system in a horizontal plane. The shovel communications system according to this embodiment includes multiple shovels 10 (such as a first shovel 10A and a second shovel 10B), the multicopter 20, and the operation apparatus 30. The relay 17 (FIG. 1) is mounted on each of the shovels 10. The shovels 10 can relay radio signals communicated between the operation apparatus 30 and the multicopter 20 in multiple stages. In FIGS. 4 and 5, communication channels of radio signals are indicated by the double-headed arrows. A multi-stage relay of radio signals makes it possible to expand a range within which communications with the multicopter 20 are performable around the operation apparatus 30.

The operation apparatus 30 is placed within, for example, a range R1A within which it is possible to directly perform communications with the first shovel 10A. Hereinafter, a range within which it is possible to directly perform communications with a relay node is referred to as the communication range of the node. The multicopter 20 selects a shovel 10 with which the multicopter 20 can transmit and receive radio signals from among the shovels 10 operating as relay nodes, and performs communications with the operation apparatus 30 through the selected shovel 10. The radio signals between the selected shovel 10 and the operation apparatus 30 may be directly communicated or be communicated via another shovel 10.

When the multicopter 20 is positioned within the communication range R1A of the first shovel 10A as indicated by the dashed line in FIGS. 4 and 5, the multicopter 20 can perform communications with the operation apparatus 30 directly or through the first shovel 10A.

When the multicopter 20 moves outside the communication range R1A of the first shovel 10A as indicated by the solid line in FIGS. 4 and 5, the multicopter 20 selects the second shovel 10B as a shovel 10 with which the multicopter 20 can transmit and receive radio signals. In this case, the multicopter 20 and the operation apparatus 30 perform communications via the first shovel 10A and the second shovel 10B. When the second shovel 10B is positioned outside the communication range R1A of the first shovel 10A, yet another shovel 10 may intervene between the first shovel 10A and the second shovel 10B.

According to the above description, when the multicopter 20 moves outside the communication range R1A of the first shovel 10A, the multicopter 20 switches the shovel 10 with which to transmit and receive radio signals. As another method, the multicopter 20 may select a shovel 10 with which to transmit and receive radio signals based on radio field strength at the position of the multicopter 20. For example, a shovel 10 transmitting a radio wave of the highest strength at the position of the multicopter 20 is selected. In this case, when the multicopter 20 crosses an equidistant surface S1 that is a group of points equally distant from the first shovel 10A and the second shovel 10B from the first shovel 10A side to the second shovel 10B side, the multicopter 20 switches the shovel 10 with which to transmit and receive radio signals from the first shovel 10A to the second shovel 10B. The multicopter 20, the shovel 10, and the operation apparatus 30 confirm their connection at predetermined control intervals. Furthermore, the multicopter 20 transmits data such as topographical data and image data to the shovel 10 with set timing. The multicopter 20 may also transmit data such as topographical data and image data to the shovel 10 in response to a transmission command sent from the shovel 10 to the multicopter 20.

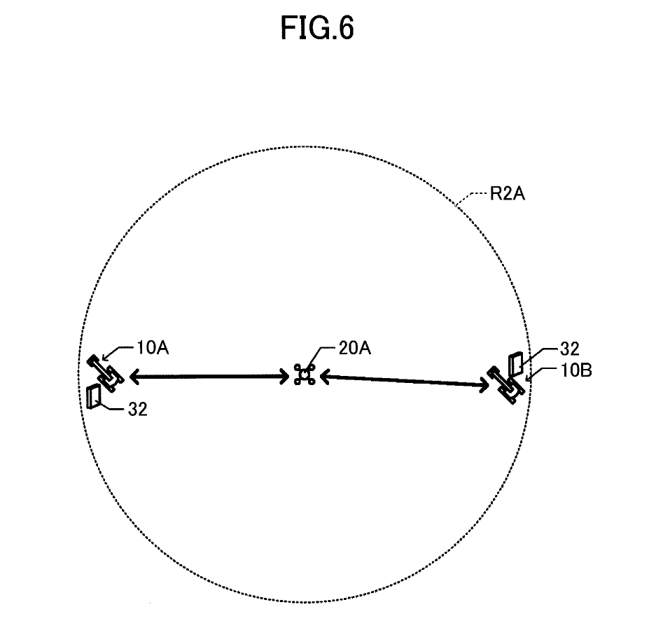

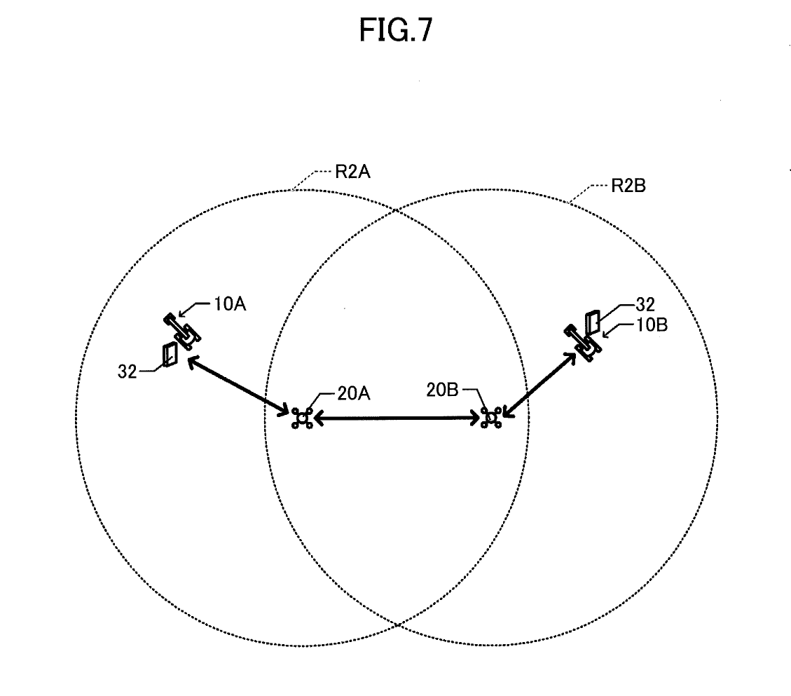

Next, a shovel communications system according to another embodiment is described with reference to FIGS. 6 and 7. In the following, differences from the embodiment as illustrated in FIGS. 1 through 3 are described, and a description of a common configuration is omitted. In the embodiment illustrated in FIGS. 1 through 3, communications are performed between the operation apparatus 30 and the multicopter 20, while according to this embodiment, communications are performed between communication terminals installed in multiple shovels 10.

FIG. 6 illustrates an arrangement of shovels and a multicopter included in the shovel communications system of this embodiment in a horizontal plane. Within a work site, the shovels 10, for example, the first shovel 10A and the second shovel 10B, are disposed. Communication terminals 32 are mounted one on each of the first shovel 10A and the second shovel 10B. The relay 17 (FIG. 1) mounted on the shovel 10 may also serve as the communication terminal 32. Thus, the shovels 10 have a communication terminal function to perform radio communications between shovels.

At least one multicopter 20 flies over the work site or its neighborhood. The multicopter 20 is controlled by the operation apparatus 30 (FIG. 1). The communications device 20-2 (FIG. 2B) mounted on the multicopter 20 has a signal relay function equivalent to that of the relay 17 mounted on the shovel 10. In FIGS. 6 and 7, communication channels of radio signals are indicated by the double-headed arrows.

In the illustration of FIG. 6, the first shovel 10A and the second shovel 10B are positioned within a communication range R2A of a first multicopter 20A. In this case, the first multicopter 20A relays radio communications between the first shovel 10A and the second shovel 10B.

In the illustration of FIG. 7, the first shovel 10A is positioned within the communication range R2A of the first multicopter 20A, while the second shovel 10B is positioned outside the communication range R2A of the first multicopter 20A. The second shovel 10B is positioned within a communication range R2B of a second multicopter 20B, while the first shovel 10A is positioned outside the communication range R2B of the second multicopter 20B. Furthermore, the first multicopter 20A and the second multicopter 20B are positioned within the other communication ranges R2B and R2A, respectively.

In this case, the first multicopter 20A and the second multicopter 20B perform a multi-stage relay of radio communications between the first shovel 10A and the second shovel 10B.

According to the embodiment illustrated in FIGS. 6 and 7, by mounting the communications device 20-2 having a relay function on the multicopter 20, it is possible to expand a range where communications are performable within a work site. When the first shovel 10A and the second shovel 10B are too distant from each other to directly transmit and receive radio waves in the embodiment illustrated in FIG. 5, it is possible to ensure communications therebetween by causing the multicopter 20 on which the communications device 20-2 having a relay function is mounted to move and hover between the first shovel 10A and the second shovel 10B.

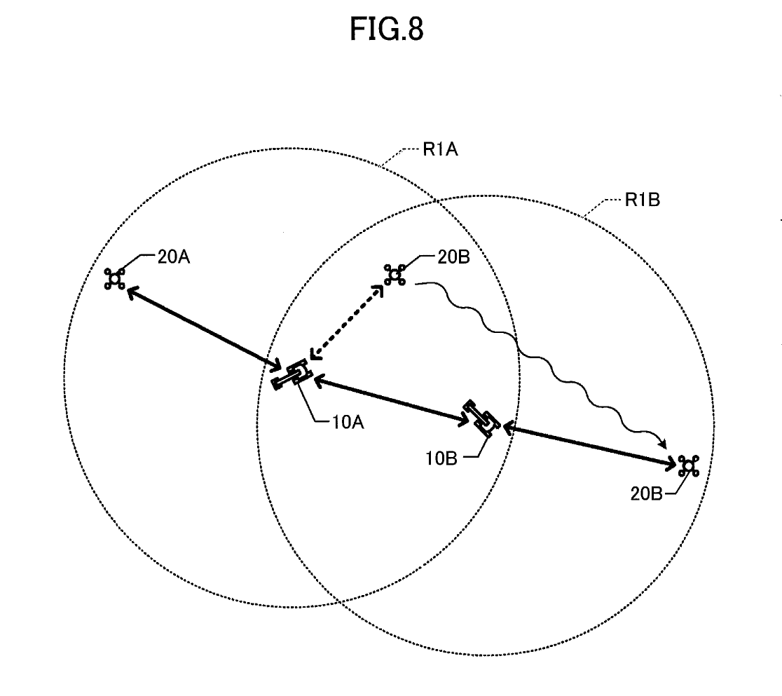

Next, a shovel communications system according to yet another embodiment is described with reference to FIG. 8. In the following, differences from the embodiment illustrated in FIGS. 1 through 3 are described, and a description of a common configuration is omitted. According to this embodiment, communications are performed between multiple multicopters 20.

FIG. 8 illustrates an arrangement of shovels and multicopters included in the shovel communications system of this embodiment in a horizontal plane. When the first multicopter 20A and the second multicopter 20B are positioned within the communication range R1A of the first shovel 10A, the first multicopter 20A and the second multicopter 20B perform radio communications through the first shovel 10A. In FIG. 8, communication channels of radio signals are indicated by the double-headed arrows.

When the second multicopter 20B moves outside the communication range R1A of the first shovel 10A, no radio waves can be transmitted or received between the second multicopter 20B and the first shovel 10A. When the second multicopter 20B is positioned within a communication range R1B of the second shovel 10B, the second multicopter 20B transmits radio waves to and receives radio waves from the second shovel 10B. In this case, the first multicopter 20A and the second multicopter 20B perform radio communications through the first shovel 10A and the second shovel 10B.

For example, in the case of acquiring image data of a ground surface of an area within which multiple shovels 10 perform work, using multiple multicopters 20, the multicopters 20 can perform communications with each other. By mounting a current position detecting device, for example, a GPS terminal, on the multicopters 20, the multicopters 20 can exchange each other's position data to avert the collision of the multicopters 20.

A multi-stage relay of communications between the multicopters 20 via the multiple shovels 10 makes it possible to expand a range where communications are performable between the multicopters 20.

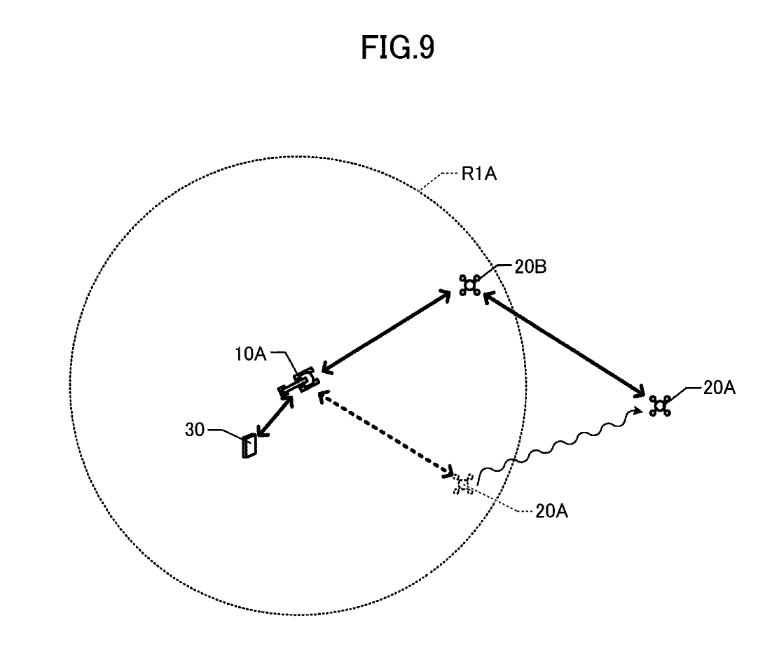

Next, a shovel communications system according to yet another embodiment is described with reference to FIG. 9. In the following, differences from the embodiment illustrated in FIGS. 4 and 5 are described, and a description of a common configuration is omitted. According to the embodiment illustrated in FIGS. 4 and 5, radio communications between the operation apparatus 30 and the multicopter 20 are relayed in multiple stages by the multiple shovels 10. According to this embodiment, radio communications between the operation apparatus 30 and the multicopter 20 are relayed by another multicopter 20.

FIG. 9 illustrates an arrangement of a shovel and multicopters included in the shovel communications system of this embodiment in a horizontal plane. When the first multicopter 20A is positioned within the communication range R1A of the first shovel 10A, the first multicopter 20A transmits radio waves to and receives radio waves from the first shovel 10A. The first shovel 10A relays radio communications between the operation apparatus 30 and the first multicopter 20A. The first multicopter 20A may directly transmit radio waves to and receive radio waves from the operation apparatus 30. In FIG. 9, communication channels of radio signals are indicated by the double-headed arrows.

When the first multicopter 20A moves outside the communication range R1A of the first shovel 10A, the first multicopter 20A transmits radio waves to and receives radio waves from the second multicopter 20B. The second multicopter 20B is positioned within the communication range R1A of the first shovel 10A. Radio communications between the operation apparatus 30 and the first multicopter 20A are relayed in multiple stages by the first shovel 10A and the second multicopter 20B.

By providing the multiple multicopters 20 with a relay function, even when no shovel 10 is present within the communication range of the first multicopter 20A, it is possible to establish communications between the first multicopter 20A and the operation apparatus 30, using another multicopter 20 as a relay node.

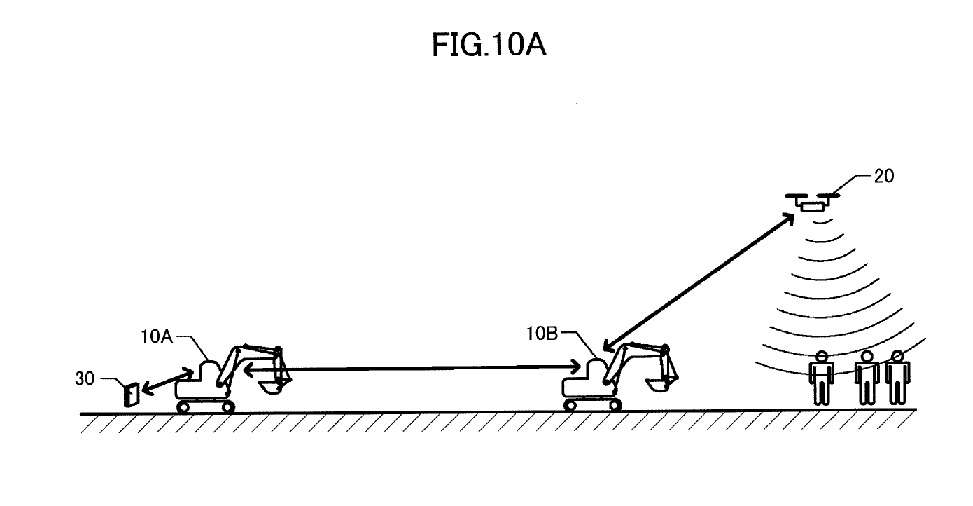

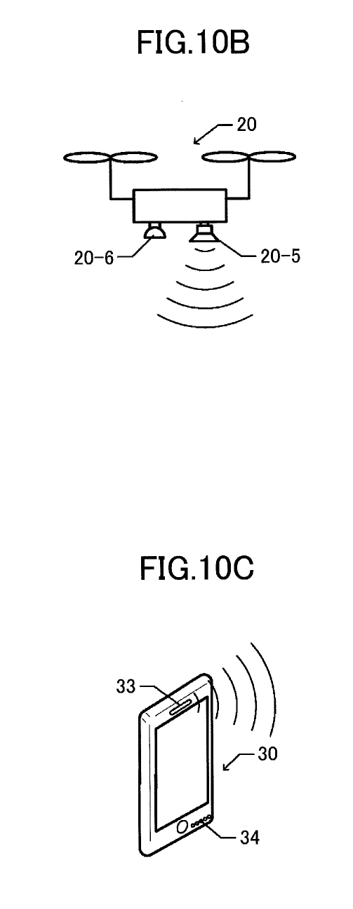

Next, a shovel communications system according to still another embodiment is described with reference to FIGS. 10A through 10C. In the following, differences from the embodiment illustrated in FIGS. 1 through 3 are described, and a description of a common configuration is omitted. According to the embodiment illustrated in FIGS. 1 through 3, the imaging device 20-4 (FIG. 2B) is mounted on the multicopter 20. According to this embodiment, the multicopter 20 has an audio output function and an audio input function. In addition, the operation apparatus 30 as well has an audio output function and an audio input function. For example, as illustrated in FIG. 10B, a loudspeaker 20-5 and a microphone 20-6 are mounted on the multicopter 20. As illustrated in FIG. 10C, a loudspeaker 33 and a microphone 34 are installed in the operation apparatus 30.

FIG. 10A illustrates an arrangement of shovels and a multicopter included in the shovel communications system of this embodiment in a vertical plane. The first shovel 10A and the second shovel 10B relay communications between the operation apparatus 30 and the multicopter 20. In FIG. 10A, communication channels of radio signals are indicated by the double-headed arrows. When sound is input to the operation apparatus 30, the operation apparatus 30 transmits audio data based on the input sound to the multicopter 20.

The multicopter 20 outputs sound from the loudspeaker 20-5 based on the received audio data. Furthermore, the multicopter 20 transmits audio data based on sound collected with the microphone 20-6 to the operation apparatus 30. The operation apparatus 30 outputs sound based on the audio data received from the multicopter 20.

According to this embodiment, it is possible to communicate information to workers working in a work site by sound, using the operation apparatus 30. Furthermore, it is possible to hear sound produced in the work site through the operation apparatus 30. Normally, the cabin of the shovel 10 is closed to maintain comfort for an operator. Therefore, sound produced outside the cabin is less likely to reach the operator in the cabin. By placing the operation apparatus 30 in the cabin, the operator can easily hear sounds outside the cabin, such as sound generated with shovel work and voice from workers working in the work site, through the operation apparatus 30.

According to the above-described embodiments, a near-field communication network using the operation apparatus 30, the multicopter 20, and the shovel 10 as nodes is constructed. Various near-field communication standards can be applied to this near-field communication network. For example, the shovel communications systems according to the above-described embodiments can be implemented by a wireless sensor network based on the Zigbee standard or the like, using the operation apparatus 30, the multicopter 20, and the shovel 10 as nodes.

Alternatively, the shovel communications systems according to the above-described embodiments can be implemented by various wireless LAN standard networks. In the case of adopting a wireless LAN standard for a radio communications network, the function of relaying radio signals can be implemented by providing the relay 17 mounted on one shovel 10 of multiple shovels 10 with the function of a wireless LAN master unit (access point) and providing the relays 17 mounted on the other shovels 10 with the function of a wireless LAN relay. In this case, the operation apparatus 30 and the multicopter 20 operate as wireless LAN slave units.

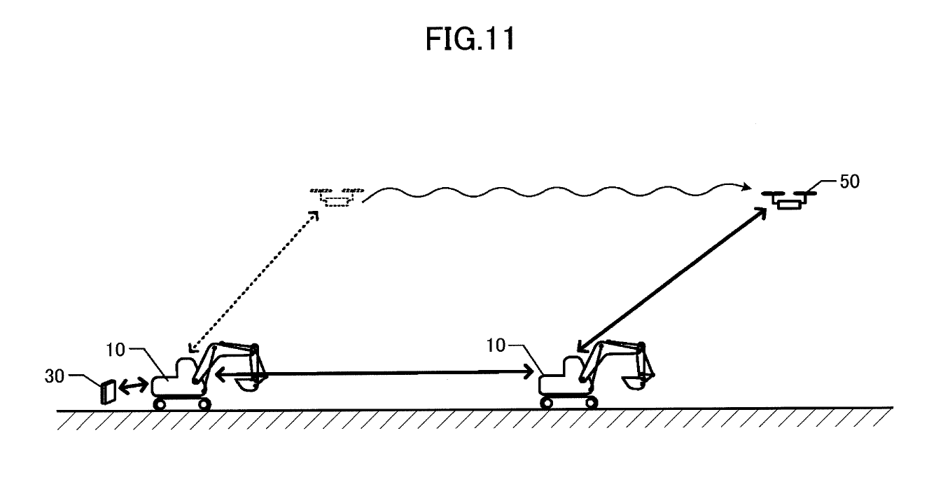

FIG. 11 illustrates a schematic diagram of a shovel communications system according to an embodiment. The shovel communications system according to the embodiment includes multiple shovels 10, a multicopter 50, and the operation apparatus 30. The operation apparatus 30 and the multicopter 50 transmit and receive radio signals. Relays mounted on the shovels 10 relay radio signals communicated between the operation apparatus 30 and the multicopter 50. In some cases, one of the shovels 10 relays communications between the operation apparatus 30 and the multicopter 50, and in other cases, two or more of the shovels 10 relay communications between the operation apparatus 30 and the multicopter 50 in multiple stages.

The multicopter 50 selects a shovel 10 with which the multicopter 50 can directly communicate, and performs communications with the operation apparatus 30, using the selected shovel 10 as a relay node. The shovel 10 with which to directly communicate is selected based on the strength of radio waves from each shovel 10. For example, the shovel 10 of the strongest radio wave strength is selected as a relay node. Alternatively, when the strength of radio waves from the shovel 10 with which the multicopter 50 is currently in direct communication falls below a threshold, the shovel 10 of the strongest radio wave strength at this point is selected as a relay node.

An imaging device, a microphone, a loudspeaker, etc., are mounted on the multicopter 50. When an operation command is transmitted from the operation apparatus 30 to the multicopter 50, the multicopter 50 operates in accordance with the received operation command. The operation command includes, for example, image acquisition, audio acquisition, and audio output.

When a command to acquire an image is transmitted from the operation apparatus 30 to the multicopter 50, the multicopter 50 acquires an image of the surroundings, and transmits image data to the operation apparatus 30. When a command to acquire audio is transmitted from the operation apparatus 30 to the multicopter 50, the multicopter 50 acquires ambient sounds and transmits audio data to the operation apparatus 30. When a command to output audio is transmitted from the operation apparatus 30 to the multicopter 50, the multicopter 50 outputs audio based on the command.

By using the multiple shovels 10 as relay nodes, it is possible to easily acquire image information and audio information in a large work site and communicate information to workers in a large work site.

The multicopter 50 operates with electric power stored in an electric power accumulator. The maximum flight time of the multicopter 50 is limited depending on the capacity of the electric power accumulator. The electric power accumulator has to be charged when the remaining amount of the electric power stored in the electric power accumulator is reduced. When the multicopter 50 has to fly over a large work site, the actual working hours of the multicopter 50 in the maximum flight time are reduced, considering time for traveling from a charging facility (equipment) to the actual working position of the multicopter 50 and time for returning from the actual working position to the charging facility (equipment).

According to the shovel communications system of the embodiment, the shovels 10 are provided with a multicopter port which the multicopter 50 can take off from and land on. The multicopter port has a charging function. The multicopter port can charge the multicopter 50 while the multicopter 50 is grounded on the multicopter port.

When the remaining amount of the stored electric power runs short, the multicopter 50 lands on the multicopter port of a nearby shovel 10 for charging. Compared with the case of returning to remote charging equipment for charging, it is possible to ensure longer actual working hours.

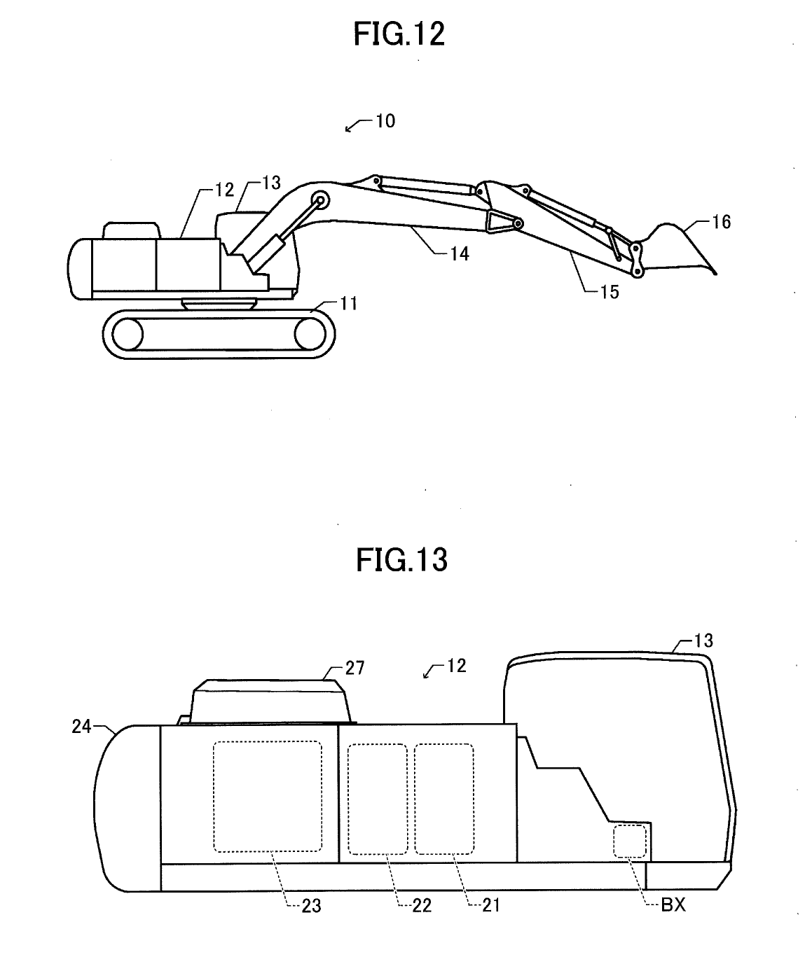

FIG. 12 illustrates a side view of a shovel 10 included in the shovel communications system according to the embodiment. The shovel 10 includes the traveling undercarriage 11, the upper rotating structure 12, the cabin 13, the boom 14, the arm 15, and the bucket 16. The upper rotating structure 12 is rotatably mounted on the traveling undercarriage through a rotating mechanism. The base of the boom 14 is attached to the upper rotating structure 12 to be vertically swingable. The arm 15 is swingably attached to the end of the boom 14. The bucket 16, which is an end attachment, is swingably attached to the end of the arm 15. As an end attachment, a breaker, a crusher or the like may be attached in place of the bucket 16.

A direction in which the boom 14 extends in a plan view (a rightward direction in FIG. 12) is defined as a forward (frontward) direction relative to the upper rotating structure 12. The cabin 13 is placed on the front left of the upper rotating structure 12. A driver's seat is provided in the cabin 13.

FIG. 13 illustrates a right side view of the upper rotating structure 12. The cabin 13 is placed on the front left of the upper rotating structure 12. A fuel tank 21 and a hydraulic oil tank 22 are placed on the right side of the center in a left-to-right direction on the rear side of the cabin 13 on the right side of the upper rotating structure 12. A toolbox BX is accommodated in front of the fuel tank 21 and the hydraulic oil tank 22. The upper surface of the toolbox BX is used as part of steps when a worker climbs onto the upper rotating structure 12.

The engine 23 is placed in the center of the upper rotating structure 12 in its left-to-right direction and on the rear side of the hydraulic oil tank 22 in its front-to-rear direction. An engine hood 27 is placed over the engine 23. A counterweight 24 is placed on the rearmost part of the upper rotating structure 12.

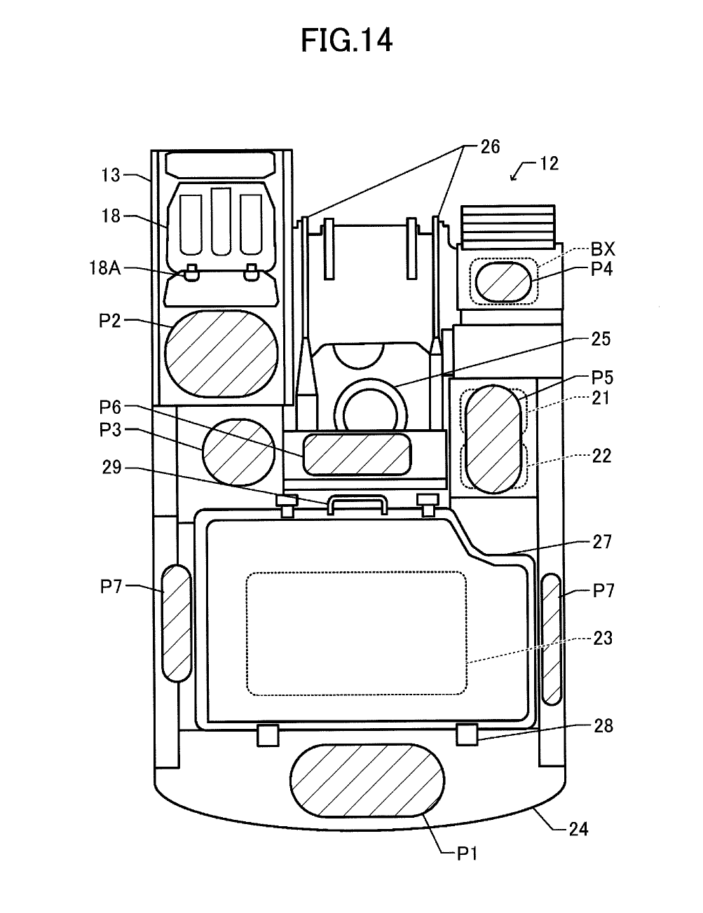

FIG. 14 illustrates a plan view of the upper rotating structure 12, which is a view taken in a direction along the axis of rotation of the upper rotating structure 12. A boom supporting bracket 26 is fixed in front of a rotation shaft 25. The boom 14 (FIG. 12) is supported by the boom supporting bracket 26 to extend forward in a plan view (upward in FIG. 14). A position at which the boom supporting bracket 26 is placed is referred to as the attachment position of the boom 14.

The engine 23 is placed rearward of the attachment position of the boom 14. The counterweight 24 is placed rearward of the engine 23.

The cabin 13 is placed on the side (left side) of the attachment position of the boom 14. A sunroof 18 is attached to the ceiling of the cabin 13 through hinges 18A. The sunroof 18 is openable and closable.

The engine hood 27 is placed vertically above the engine 23. The engine hood 27 is supported on a structure of the upper rotating structure 12 through hinges 28. A worker can open the engine hood 27 by lifting a handle 29 attached on the side opposite from the hinges 28. By opening the engine hood 27, it is possible to perform maintenance work for the engine 23.

The fuel tank 21 and the hydraulic oil tank 22 are placed in front of the engine 23 in the front-to-rear direction and on the right side of the attachment position of the boom 14 in the left-to-right direction. The toolbox BX is placed in front of the fuel tank 21 and the hydraulic oil tank 22. The toolbox BX contains maintenance tools.

Next, possible locations for placing the multicopter port are described. It is necessary to install terminals and wires for charging in the multicopter port. Therefore, it is not preferable to place the multicopter port in a location whose posture is changed by a movable mechanism such as an opening and closing mechanism.

A position P1 that is over the counterweight 24 in a plan view can be a possible placement location of the multicopter port. A position P2 that is over the cabin 13 in a plan view, specifically, the top of the ceiling of the cabin 13, can be another possible placement location of the multicopter port. It is preferable, however, to place the multicopter port at a position that does not overlap the openable and closable sunroof 18.

Furthermore, a position P3 that is overlaid by the cabin 13 when viewed from the front side of the upper rotating structure 12 and is between the cabin 13 and the engine 23 in the front-to-rear direction can be a possible placement location of the multicopter port.

Besides, a position P4 that is over the toolbox BX and a position P5 that is over at least one of the fuel tank 21 and the hydraulic oil tank 22 in a plan view can also be possible placement locations of the multicopter port. Moreover, a position P6 between the attachment position of the boom 14 and the engine 23 and positions P7 lateral to the engine 23 in a plan view can also be possible placement locations of the multicopter port.

The multicopter port is placed at one of the above-described possible positions P1 through P7.

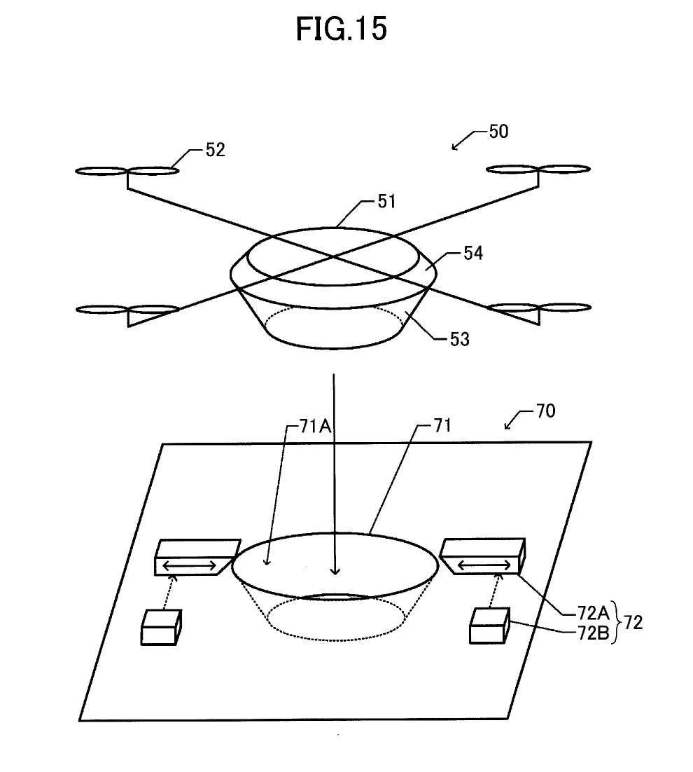

FIG. 15 illustrates a perspective view of a multicopter port and the multicopter 50 landing on the multicopter port.

A multicopter port 70 includes a recess 71 and a fixing mechanism 72. The recess 71 accommodates part of the multicopter 50. A side surface 71A of the recess 71 fits the side surface of an inverted truncated cone that increases in width in an upward direction. Here, the configuration where “the side surface 71A fits the side surface of an inverted truncated cone” includes not only a configuration where the side surface 71A sticks fast to the side surface of an inverted truncated cone but also a configuration where the side surface 71A is provided with multiple projections and an inverted truncated cone is supported by the side surface 71A with the side surface of the inverted truncated cone contacting the tips of the projections.

The fixing mechanism 72 fixes the multicopter 50 accommodated in the recess 71. For example, the fixing mechanism 72 includes fixing members 72A and a drive unit 72B. The drive unit 72B moves the fixing members 72A to hold a body 51 of the multicopter 50 from both sides to fix the multicopter 50.

The multicopter 50 includes the body 51 and multiple rotor blades 52. The body 51 includes a side surface 53 that fits the side surface 71A of the recess 71. Once the multicopter 50 is accommodated in the recess 71, the side surface 53 of the multicopter 50 contacts the side surface 71A of the recess 71. Because the side surface 71A of the recess 71 spreads outward in an upward direction, the landing-time positional deviation of the multicopter 50 is automatically eliminated. Furthermore, because the side surface of a truncated cone is infinite-time rotationally symmetric with respect to its central axis, the multicopter 50 can enter the multicopter port 70 at any azimuth.

The body 51 of the multicopter 50 includes a side surface (hereinafter, upper side surface) 54, inclined in an opposite direction from the side surface 53 that fits the side surface 71A of the recess 71, on the upper side of the side surface 53. The upper side surface 54 fits the side surface of a truncated cone that decreases in width in an upward direction.

The fixing members 72A include a contact surface that contacts the upper side surface 54. This contact surface faces obliquely downward. The fixing members 72A are arranged to face each other across the recess 71. With the body 51 of the multicopter 50 being accommodated in the recess 71, the fixing members 72A move toward each other. As a result, the body 51 of the multicopter 50 is pressed downward to be fixed to the multicopter port 70.

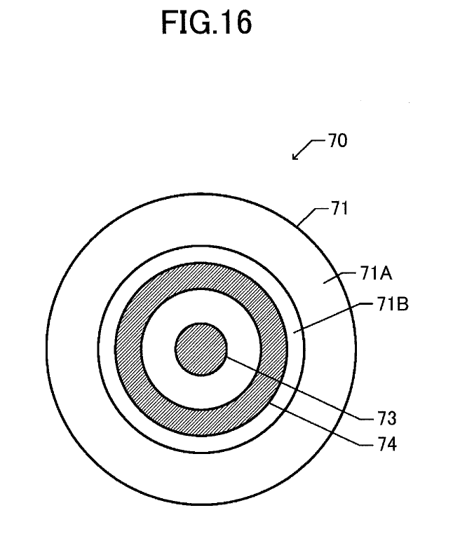

FIG. 16 illustrates a plan view of the recess 71 of the multicopter port 70. The side surface 71A and a bottom surface 71B of the recess 71 are exposed. A pair of charging terminals 73 and 74 are placed on the bottom surface 71B of the recess 71. Each of the charging terminals 73 and 74 has a planar shape that is rotationally symmetric with respect to the central axis of the side surface 71A. For example, the charging terminals 73 and 74 have a circular or annular planar shape.

Once the body 51 of the multicopter 50 is accommodated in the recess 71, a pair of charging terminals of the multicopter 50 contact the charging terminals 73 and 74 of the multicopter port 70. Because the planar shape of each of the charging terminals 73 and 74 is rotationally symmetric, the charging terminals of the multicopter 50 and the charging terminals 73 and 74 of the multicopter port 70 can be properly connected whichever azimuth the multicopter 50 may land at.

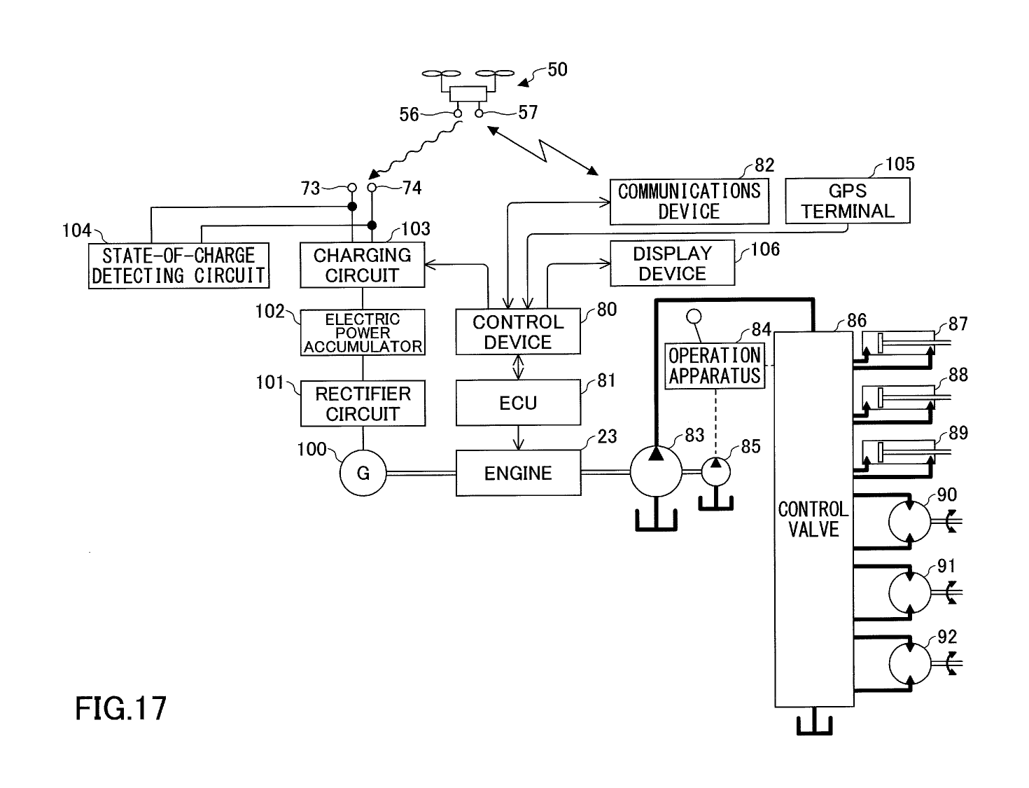

FIG. 17 illustrates a block diagram of the shovel 10 according to the embodiment. The block diagram of FIG. 17 is different from the block diagram of FIG. 2D in that the shovel 10 includes a communications device 82, a charging circuit 103, a state-of-charge detecting circuit 104, and the charging terminals 73 and 74 and that the multicopter 50 includes charging terminals 56 and 57, but is otherwise equal to the block diagram of FIG. 2D. Therefore, a description of a common part is omitted, and differences are described in detail.

The charging circuit 103 supplies the output electric power of the electric power accumulator 102 to the charging terminals 73 and 74 of the multicopter port 70 as charging electric power. The charging circuit 103 is controlled by the control device 80.

The communications device 82 is controlled by the control device 80 to perform communications with the multicopter 50. The communications device 82 can also operate as a relay. In response to a request from the multicopter 50, the control device 80 transmits information indicating whether the multicopter port 70 (FIG. 15) can charge the multicopter 50 to the multicopter 50. Furthermore, the control device 80 transmits information on the current position of the shovel 10 detected by the GPS terminal 105 to the multicopter 50.

The multicopter 50 in need of charging lands on the multicopter port 70 (FIG. 15) with the permission of the shovel 10. As a result, the charging terminals 56 and 57 of the multicopter 50 are connected to the charging terminals 73 and 74, respectively, of the multicopter port 70.

The state-of-charge detecting circuit 104 detects a physical quantity that depends on the state of charge of the multicopter 50 that is landed on the multicopter port 70. For example, the state-of-charge detecting circuit 104 detects the open-circuit voltage of the electric power accumulator mounted on the multicopter 50. The control device 80 calculates the state of charge of the multicopter 50 based on the detection result of the state-of-charge detecting circuit 104, and displays the calculation result on the display device 106.

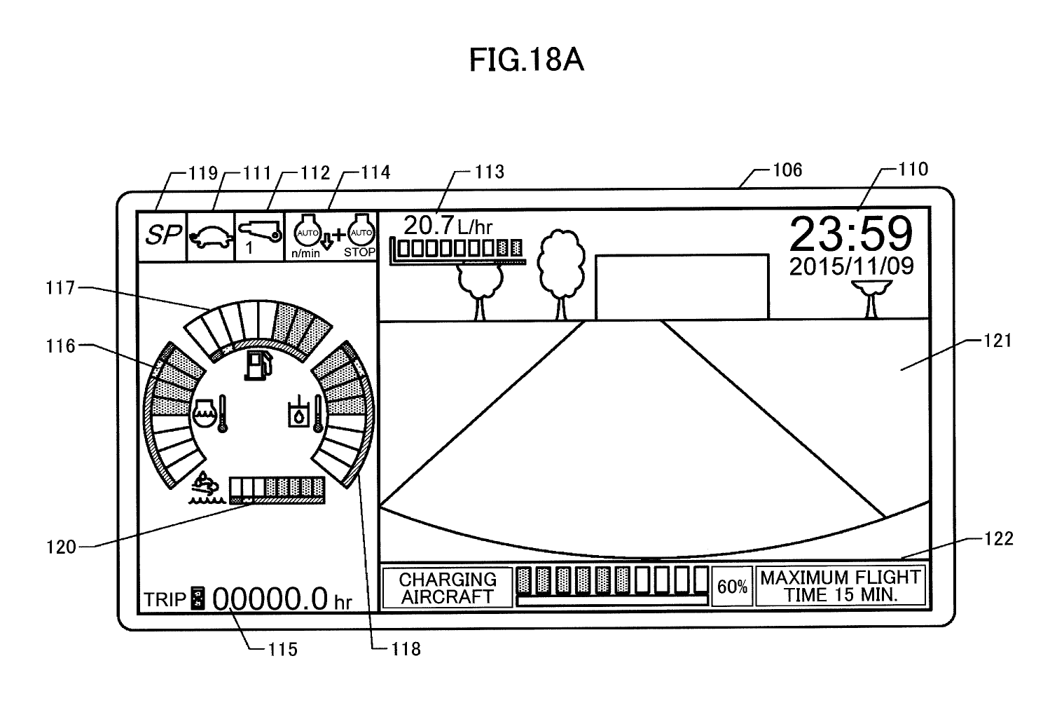

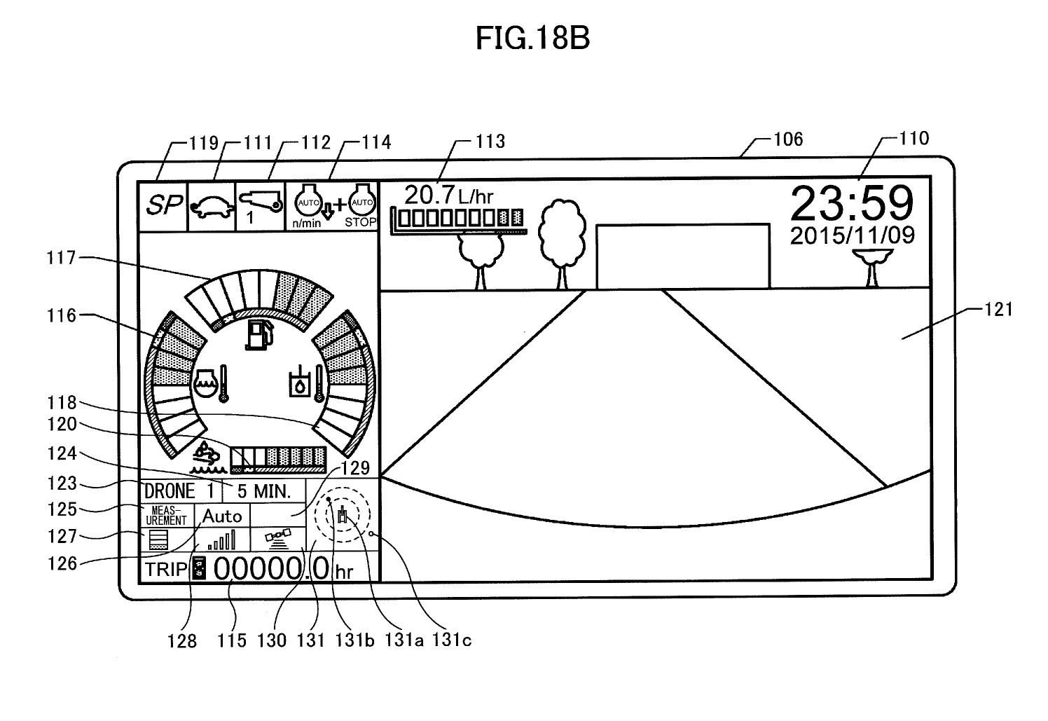

FIG. 18A illustrates an image displayed on the display device 106 when the multicopter 50 is landed on the multicopter port 70. A current date and time is displayed in a date and time display area 110 in the screen of the display device 106. A current traveling mode is graphically displayed in a traveling mode display area 111. Examples of the traveling mode include low-speed mode and high-speed mode. A turtle-shaped figure is displayed in the low-speed mode, and a rabbit-shaped figure is displayed in the high-speed mode.

An image representing a currently-attached end attachment and a number corresponding to the end attachment are displayed in an end attachment display area 112. End attachments attachable to the shovel 10 include a bucket, a rock drill, a grapple, and a lifting magnet. In the illustration of FIG. 18A, a rock drill-shaped figure and a number “1” corresponding to a rock drill are displayed.

Current average fuel efficiency is displayed as an image in an average fuel efficiency display area 113. In the illustration of FIG. 18A, average fuel efficiency is displayed in a numerical value and a bar graph.

The control mode of the engine 23 (FIG. 17) is displayed as an image in an engine control mode display area 114. In the illustration of FIG. 18A, the case where the control mode of the engine 23 is “automatic deceleration and automatic stop mode” is illustrated. Other control modes of the engine 23 include “automatic deceleration mode,” “automatic stop mode,” and “manual deceleration mode.”

The cumulative operating time of the engine 23 is numerically displayed in an engine operating time display area 115.

The current water temperature of engine coolant water is displayed as an image in a coolant water temperature display area 116. In the illustration of FIG. 18A, the water temperature of engine coolant water is displayed in an arc-shaped bar graph.

The remaining amount of fuel stored in the fuel tank 21 (FIG. 12) is displayed as an image in a remaining fuel amount display area 117. In the illustration of FIG. 18A, the remaining amount of fuel is displayed in an arc-shaped bar graph.

The oil temperature of hydraulic oil in the hydraulic oil tank 22 (FIG. 12) is displayed as an image in a hydraulic oil temperature display area 118. In the illustration of FIG. 18A, the temperature of hydraulic oil is displayed in an arc-shaped bar graph.

A current rotational speed mode is displayed as an image in a rotational speed mode display area 119. Examples of the rotational speed mode include SP mode, H mode, A mode, and idling mode.

The remaining amount of urea water in a urea water tank is displayed as an image in a remaining urea water amount display area 120. In the illustration of FIG. 18A, a current remaining amount of urea water is displayed in a rectilinear bar graph.

An image of a camera mounted on the shovel 10 is displayed in a camera image display area 121. For example, the camera captures images of an area lateral to and an area behind the upper rotating structure 12.

The state of charge of the multicopter 50 that is landed on the multicopter port 70 (FIG. 15) is displayed as an image in a multicopter state-of-charge display area 122. In FIG. 18A, the state of charge of the multicopter 50 is displayed in a numerical value and a bar graph. In addition, a maximum flight time under a current state of charge is numerically displayed. The relationship between the state of charge and the maximum flight time is prestored in, for example, the control device 80 (FIG. 17). The maximum flight time is calculated based on this relationship and the current state of charge of the multicopter 50.

Furthermore, the usage status of the multicopter port 70 is displayed in the multicopter state-of-charge display area 122. Examples of usage statuses include VACANT, IN PREPARATION FOR START OF CHARGING, CHARGING AIRCRAFT, and CHARGING COMPLETED. An operator of the shovel 10 can recognize the usage status of the multicopter port 70 and the state of charge of the multicopter 50 by image information displayed on the display device 106.

FIG. 18B illustrates an image displayed on the display device 106 when the multicopter 50 is not landed on the multicopter port 70. The image of FIG. 18B is different from the image of FIG. 18A in including display areas 123 through 131 in place of the multicopter state-of-charge display area 122, but is otherwise the same. Therefore, a description of a common part is omitted, and differences are described in detail.

Information showing the condition of the multicopter 50 flying around the shovel 10 is displayed in the display areas 123 through 131. When multiple multicopters 50 are flying around the shovel 10, one of the multicopters 50 is selected and information on the selected one is displayed.

Specifically, the identification information of the multicopter 50 is displayed in the display area 123. In the illustration of FIG. 18B, an identification name of DRONE 1 is displayed as the identification information of the multicopter 50 flying nearest to the shovel 10. The maximum flight time of the multicopter 50 is displayed in the display area 124. The illustration of FIG. 18B shows that the maximum flight time is “5 min.”

The current operating mode of the multicopter 50 is displayed in the display area 125. Examples of operating modes include measurement mode and imaging mode (camera mode). The measurement mode represents the state where the multicopter 50 is collecting topographical data as construction data. The imaging mode represents the state where the multicopter 50 is transmitting captured images in real time. The illustration of FIG. 18B shows that the current operating mode is measurement mode.

The current flight mode of the multicopter 50 is displayed in the display area 126. Examples of flight modes include automatic flight mode, tracking flight mode, and manual flight mode. The automatic flight mode represents the state where the multicopter 50 is flying along a preset flight route. The tracking flight mode represents the state where the multicopter 50 is flying after a particular tracking target (for example, the shovel 10). The manual flight mode represents the state where an operator is flying the multicopter 50 through the operation apparatus 30 or the like. The illustration of FIG. 18B shows that the current flight mode is the automatic flight mode.

The remaining power of the battery mounted on the multicopter 50 is displayed in the display area 127. The illustration of FIG. 18B shows that the remaining power of the battery is the lowest of four levels.

The condition of communications between the shovel 10 and the multicopter 50 is displayed in the display area 128. The illustration of FIG. 18B shows that the condition of communications is the highest (stablest) of five levels.

An error code is displayed in the display area 129 when an error occurs. Examples of errors include errors related to the multicopter 50, communication-related errors, and errors related to the shovel 10. The illustration of FIG. 18B shows the state where no error code is displayed, namely, the state where no error has occurred.

The reception condition of a GPS signal is displayed in the display area 130. The illustration of FIG. 18B shows that the reception condition is the highest (stablest) of four levels.

The positional relationship of the shovel 10 and the multicopter 50 is displayed in the display area 131. Specifically, in the display area 131, an icon 131a of the shovel 10 is displayed in its center, and points 131b and 131c representing the positions of multicopters 50 flying around the shovel 10 are displayed. The blinking point 131b indicated by a black circle corresponds to DRONE 1 (the selected multicopter 50 flying nearest to the shovel 10). The lighted point 131c indicated by a white circle corresponds to DRONE 2 (non-selected multicopter 50). The operator may, for example, touch the point 131c, thereby selecting DRONE 2 and causing information on DRONE 2 to be displayed in the display areas 123 through 130.

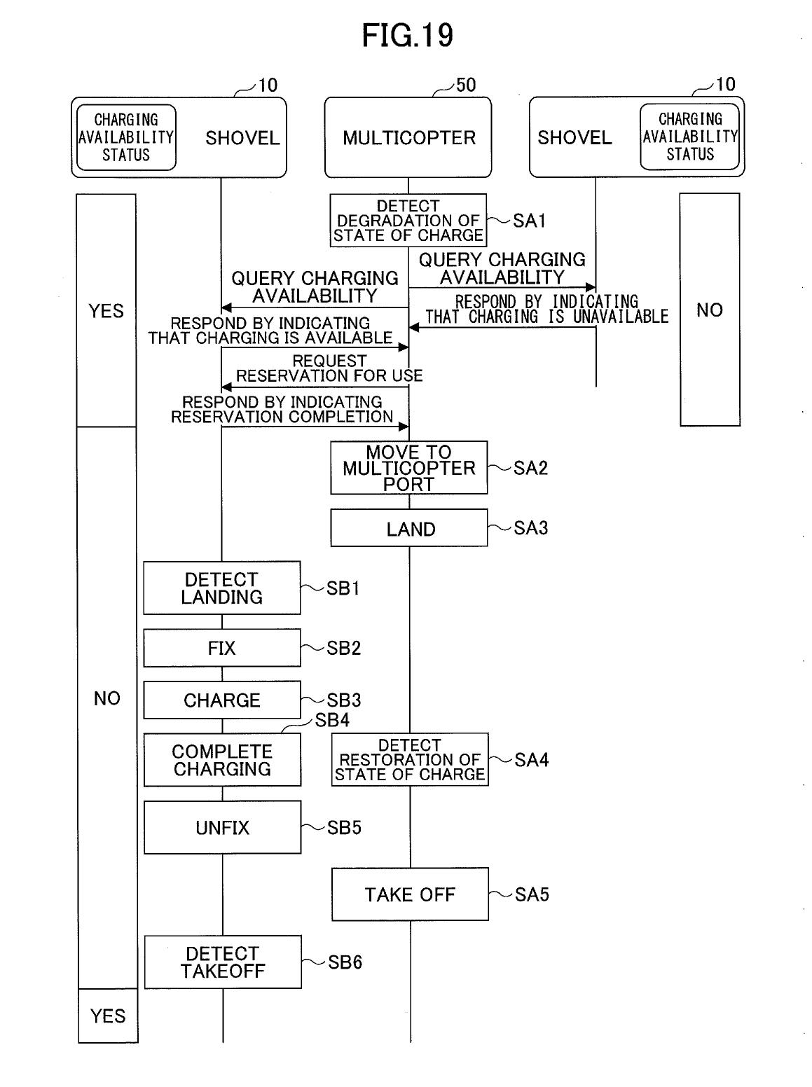

FIG. 19 illustrates a sequence of signals communicated between the shovel 10 and the multicopter 50 and an operation flow. Charging availability status is stored in the control device 80 of the shovel 10. For example, when the multicopter port 70 is already in use or the multicopter 50 is due to land, the charging availability status is set to NO. When the multicopter port 70 is vacant and no multicopter 50 is due to land, the charging availability status is set to YES.

In response to detecting degradation of the state of charge (step SA1), the multicopter 50 queries shovels 10 from which radio waves are receivable at the moment about charging availability. In response to the query, the shovels 10 determine whether charging from the multicopter port 70 is available, and return a determination result to the multicopter 50. Specifically, if the charging availability status is NO, the shovels 10 respond by notifying the multicopter 50 that charging is unavailable. If the charging availability status is YES, the queried shovels 10 respond by notifying the multicopter 50 that charging is available.

The multicopter 50 selects one of the shovels 10 whose reply indicates that charging is available. The selection of the shovel 10 may be performed, for example, based on radio field strength or based on a distance from the multicopter 50. For example, the shovel 10 whose radio field strength is the strongest or the shovel 10 nearest to the multicopter 50 may be selected.

The multicopter 50 makes a request to the selected shovel 10 for a reservation for use. In response to reception of the request for a reservation for use, the shovel 10 sets the charging availability status to NO, and thereafter responds by notifying the multicopter 50 of completion of the reservation.

The multicopter 50 moves to the multicopter port 70 of the shovel 10 that has responded by indicating completion of the reservation (step SA2). When arriving over the multicopter port 70, the multicopter 50 starts to descend and lands on the multicopter port 70 (step SA3). At this point, for example, the multicopter 50 can obtain an image of the multicopter port 70 and fine-tune its position relative to the multicopter port 70 while analyzing the image.

In response to detection of the landing of the multicopter 50 (step SB1), the control device 80 (FIG. 17) of the shovel 10 puts the fixing mechanism 72 (FIG. 15) into operation to fix the multicopter 50 to the multicopter port 70 (step SB2). Thereafter, the control device 80 controls the charging circuit 103 to charge the multicopter 50 (step SB3). When charging is completed, the control device 80 detects completion of charging (step SB4), and the multicopter 50 detects restoration of the state of charge (step SA4). Thereafter, the control device 80 puts the fixing mechanism 72 into operation to unfix the multicopter 50 (step SB5).

After being unfixed, the multicopter 50 takes off from the multicopter port 70 (step SA5). In response to detection of the takeoff of the multicopter 50 (step SB6), the control device 80 sets the charging availability status to YES.

According to the above-described embodiment, charging is performed by bringing the charging terminals 56 and 57 of the multicopter 50 into contact with the charging terminals 73 and 74 (FIG. 17), respectively, of the multicopter port 70, while it is also possible to charge the multicopter 50 by inductive charging. In this case, a sender coil may be placed in the multicopter port 70, and a receiver coil may be placed in the multicopter 50.

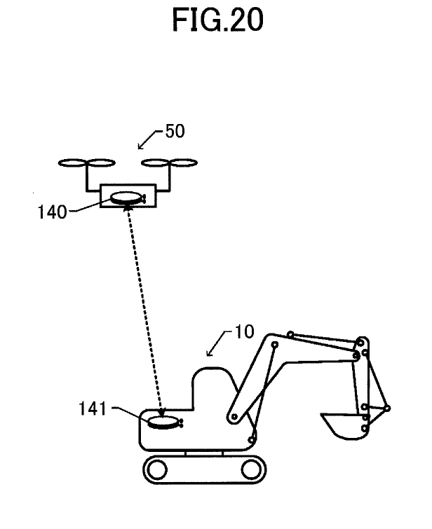

A shovel communications system according to another embodiment is described with reference to FIG. 20. In the following, differences from the above-described embodiment are described, and a description of a common part is omitted. According to the above-described embodiment, the multicopter 50 is charged while being landed on the multicopter port 70 of the shovel 10. According to this embodiment, the multicopter 50 is charged while hovering in the air around the shovel 10.

FIG. 20 illustrates a schematic diagram of the shovel 10 and the multicopter 50 according to this embodiment. A power extraction coil 140 is installed in the multicopter 50. A power transmission coil 141 that resonates with the power extraction coil 140 is installed in the shovel 10. Charging power is supplied from the charging circuit 103 (FIG. 17) to the power transmission coil 141.

Electric power is transferred from the power transmission coil 141 to the power extraction coil 140 through the magnetic resonance of the power extraction coil 140 and the power transmission coil 141. The multicopter 50 is charged with the electric power received by the power extraction coil 140.

According to this embodiment, it is possible to charge the multicopter 50 while hovering the multicopter 50 in the air around the shovel 10 without landing the multicopter 50 on the multicopter port 70 of the shovel 10.

Various aspects of the subject matter described herein may be set out non-exhaustively in the following numbered clauses:

1. A shovel communications system including:

a multicopter configured to fly in response to an operation command;

an operation apparatus configured to communicate with the multicopter; and

a shovel, the shovel including
a relay configured to relay a radio signal communicated between the operation apparatus and the multicopter;
a traveling undercarriage;
an upper rotating structure rotatably supported on the traveling undercarriage;
a multicopter port provided on the upper rotating structure, wherein the multicopter is configured to land on and take off from the multicopter port; and
a charging circuit configured to supply charging electric power to the multicopter landed on the multicopter port.

2. A shovel including:

a traveling undercarriage;

an upper rotating structure rotatably supported on the traveling undercarriage;

a multicopter port provided on the upper rotating structure, wherein a multicopter is configured to land on and take off from the multicopter port; and

a charging circuit configured to supply charging electric power to the multicopter landed on the multicopter port.

3. The shovel of clause 2, further including:

a boom attached to the upper rotating structure to be vertically swingable, the boom extending frontward,

wherein the upper rotating structure includes
an engine placed rearward of an attachment position of the boom; and
a counterweight placed rearward of the engine, and

wherein the multicopter port is placed at a position over the counterweight in a plan view.

4. The shovel of clause 2, further including:

a cabin mounted on the upper rotating structure,

wherein the multicopter port is placed at a position over the cabin in a plan view.

5. The shovel of clause 2, further including:

a boom attached to the upper rotating structure to be vertically swingable, the boom extending in a frontward direction relative to the upper rotating structure, the frontward direction being parallel to a front-to-rear direction of the upper rotating structure; and

a cabin mounted on a side of an attachment position of the boom in a left-to-right direction of the upper rotating structure,

wherein the upper rotating structure includes
an engine placed rearward of the attachment position of the boom; and
a fuel tank, a hydraulic oil tank, and a toolbox that are placed in front of the engine and on an opposite side of the attachment position of the boom from the cabin, the toolbox containing maintenance tools, and

wherein the multicopter port is placed at one or more of:

a position that is overlaid by the cabin when viewed from a front side of the upper rotating structure and is between the cabin and the engine in the front-to-rear direction;

a position between the engine and the attachment position of the boom;

a position over the fuel tank in a plan view;

a position over the hydraulic oil tank in the plan view;

a position over the toolbox in the plan view;

a position on a first side of the engine in the left-to-right direction in the plan view; and

a position on a second side of the engine opposite to the first side in the left-to-right direction in the plan view.

6. The shovel of clause 2, further including:

a communications device configured to communicate with the multicopter; and

a control device configured to control the charging circuit, the control device being configured to, in response to reception of a query from the multicopter about availability of charging from the multicopter port, determine whether the charging is available and return a determination result to the multicopter.

7. The shovel of clause 6, further including:

a state-of-charge detecting circuit configured to detect a physical quantity that depends on a state of charge of the multicopter landed on the multicopter port; and

a display device,

wherein the control device is configured to calculate the state of charge of the multicopter landed on the multicopter port based on a detection result of the state-of-charge detecting circuit, and to display a calculation result on the display device.

8. The shovel of clause 7, wherein the control device is configured to calculate a maximum flight time of the multicopter based on the calculation result of the state of charge of the multicopter, and to display the calculated maximum flight time on the display device.

9. The shovel of clause 2, wherein the multicopter port includes a recess configured to accommodate a part of the landed multicopter, the recess including a side surface that fits a side surface of a cone that increases in width in an upward direction.

10. A shovel including:

a traveling undercarriage;

an upper rotating structure rotatably mounted on the traveling undercarriage;

a power transmission coil configured to resonate with a power extraction coil installed in a multicopter; and

a charging circuit configured to supply electric power to the power transmission coil.

11. A multicopter configured to land on and take off from a multicopter port provided on an upper rotating structure of a shovel, the multicopter including:

a charging terminal configured to connect to a charging terminal placed in the multicopter port.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. A shovel communications system comprising:
a multicopter configured to fly in response to an operation command;
an operation apparatus configured to transmit a radio signal corresponding to the operation command when the operation command is input to the multicopter, and to output information when receiving the information from the multicopter; and
a shovel including a relay configured to relay a radio signal communicated between the operation apparatus and the multicopter.

2. The shovel communications system as claimed in claim 1, wherein the operation apparatus is placed outside the shovel.

3. The shovel communications system as claimed in claim 1, further comprising:
at least one additional shovel including a relay configured to relay the radio signal communicated between the operation apparatus and the multicopter,
wherein the relay of the shovel and the relay of the at least one additional shovel are configured to relay the radio signal communicated between the operation apparatus and the multicopter in multiple stages.

4. The shovel communications system as claimed in claim 3, wherein the multicopter is configured to select a shovel from among the shovel and the at least one additional shovel based on a radio field strength of a radio wave from each of the shovel and the at least one additional shovel, and to communicate with the operation apparatus through the selected shovel.

5. The shovel communications system as claimed in claim 3, wherein
at least two shovels among the shovel and the at least one additional shovel are configured to perform radio communications with each other, and
the multicopter includes a relay configured to relay a radio signal communicated between the at least two shovels.

6. The shovel communications system as claimed in claim 1, further comprising:
an additional multicopter configured to fly in response to an operation command,
wherein the relay of the shovel is configured to relay a radio signal communicated between the multicopter and the additional multicopter.

7. The shovel communications system as claimed in claim 1, wherein
the operation apparatus is configured to receive an audio that is input thereto, and to transmit audio data based on the input audio to the multicopter, and
the multicopter is configured to output an audio based on received audio data.

8. The shovel communications system as claimed in claim 1, wherein
the multicopter is configured to receive an audio that is input thereto, and to transmit audio data based on the input audio to the operation apparatus, and
the operation apparatus is configured to output an audio based on received audio data.

9. The shovel communications system as claimed in claim 1, wherein
the multicopter includes an imaging device configured to capture image data,
the multicopter is configured to transmit the captured image data to the operation apparatus,
the operation apparatus includes a display screen, and
the operation apparatus is configured to display an image on the display screen based on the image data received from the multicopter.

10. A shovel comprising:
a relay configured to relay a radio signal communicated between a multicopter and an operation apparatus to which an operation command to the multicopter is input.

11. The shovel as claimed in claim 10, wherein the operation apparatus is mounted on the shovel.

12. The shovel as claimed in claim 10, wherein the relay is configured to relay the radio signal in multiple stages via a relay mounted on another shovel.

13. A multicopter comprising:
a communications device configured to receive a radio signal from an operation apparatus and transmit a radio signal to the operation apparatus, via a relay mounted on a shovel.
